(19) United States
(12) Patent Application Publication
(10) Pub. No.: US 2024/0219932 A1
(43) Pub. Date: Jul. 4, 2024

(54) REDUNDANT SYSTEMS FOR CONTROLLING A REMOTELY PILOTED VEHICLE

(71) Applicant: Urban Robotics, Inc., Las Vegas, NV (US)

(72) Inventors: William Joseph REEVES, Silverthorne, CO (US); Anand NANDAKUMAR RAGHAV, Las Vegas, NV (US)

(21) Appl. No.: 18/530,436

(22) Filed: Dec. 6, 2023

Related U.S. Application Data
(60) Provisional application No. 63/386,288, filed on Dec. 6, 2022.

(51) Int. Cl. G05D 1/87; G05D 1/227; G05D 1/617; G05D 109/10; G05D 111/30; H04L 43/10

(52) U.S. Cl. CPC G05D 1/87; G05D 1/2274; G05D 1/617; H04L 43/10; G05D 2109/10; G05D 2111/32

(57) ABSTRACT

Systems and methods for redundant braking and/or of remotely piloted vehicles are described. A redundant braking system includes a first onboard computing unit configured to receive sync data regularly from a main computing unit, receive heartbeat signal through a communication network from a remote pilot control unit, determine network failure if the heartbeat signal is not received for more than a threshold period of time, and generate a braking command. The system includes arrangements to activate brakes of the vehicle based on the braking command received from the local computing unit. The system may also generate a steering command to change the lane of the vehicle and park at a safe spot.

### BACKGROUND

Redundant control systems (e.g., including steering and braking systems) have become important safety features in automobiles, especially as technology facilitates autonomous, semi-autonomous, and/or remotely piloted vehicles. The importance of redundant control systems becomes more profound as reliance on communication networks for driving decisions increases. Remotely piloted vehicles, where a driverless vehicle is driven on the road by a remote pilot who receives real environmental data from a vehicle at a remote station and controls the vehicle from the remote station, have dependency on a communication network to deliver data from the vehicle. If the communication network fails, the remotely piloted vehicle may have limited connectivity to the remote pilot and thus, reduce the ability of the remote pilot to control the vehicle.

While there are redundant braking systems known in the art to provide safety to autonomous or semi-autonomous vehicles, some such systems require tight integration with the vehicle braking system, which may preclude retrofitting existing vehicles. For example, there are many advanced cars that can be configured to be remotely piloted. To update these cars, redundant braking systems are preferably added to enhance safety. However, many existing braking systems require tight integration and hence are not suitable solutions once the vehicle has been manufactured.

Other approaches may be provided for systems of the type which operates normally in a brake-by-wire mode. In such systems, hydraulic pressure is applied to braking devices at the vehicle wheels in proportion to the driver's braking demand as sensed electronically at a brake pedal. If the brake-by-wire mode should fail, such systems may operate in a push-through mode, wherein hydraulic pressure is applied to the braking devices at the vehicle wheels by way of a master cylinder coupled mechanically to the brake pedal. However, as the brake pedal needs to be pushed manually, such systems are not possible in a remotely driven vehicle.

Therefore, there is a need for a redundant braking system and method for controlling a remotely piloted vehicle in the event of a network failure.

### SUMMARY

In some aspects, the techniques described herein relate to a redundant braking system for a remotely piloted vehicle, the system including: a local computing unit configured, at a vehicle, to receive sync data regularly from a main computing unit; receive a heartbeat signal through a communication network from a remote pilot control unit; determine network failure if the heartbeat signal is not received for more than a threshold period of time; and issue a braking command; and an arrangement configured to control the vehicle based on the braking command received from the local computing unit.

In some aspects, the techniques described herein relate to a redundant braking system for a remotely piloted vehicle, the system including: a local computing unit configured, at a vehicle, to receive sync data regularly from a main computing unit; receive a heartbeat signal through a communication network from a remote pilot control unit; determine network failure if the heartbeat signal is not received for more than a threshold period of time; and issue a braking command; and an electromechanical arrangement configured to actuate a brake pedal of the vehicle based on the braking command received from the local computing unit.

In some aspects, the techniques described herein relate to a redundant braking method for a remotely piloted vehicle, the method including: receiving, at a local computing unit configured at a vehicle, sync data regularly from a main computing unit; receiving, at the local computing unit, a heartbeat signal through a communication network from a remote pilot control unit; determining, at the local computing unit, network failure if the heartbeat signal is not received for more than a threshold period of time; generating, by the local computing unit, a braking command; and actuating, through an electromechanical arrangement, a brake pedal of the vehicle based on the braking command received from the local computing unit.

In some aspects, the techniques described herein relate to a redundant braking system for a remotely piloted vehicle, the system including: a local computing unit configured, at a vehicle, to receive sync data regularly from a main computing unit; receive a heartbeat signal through a communication network from a remote pilot control unit; determine network failure if the heartbeat signal is not received for more than a threshold period of time; and issue a braking command; and an electromechanical arrangement to apply hydraulic force directly on each of a plurality of hydraulic lines of a braking system of the vehicle based on the braking command received from the local computing unit.

In some aspects, the techniques described herein relate to a redundant braking method for a remotely piloted vehicle, the method including: receiving, at a local computing unit configured at a vehicle, sync data regularly from a main computing unit; receiving, at the local computing unit, a heartbeat signal through a communication network from a remote pilot control unit; determining, at the local computing unit, network failure if the heartbeat signal is not received for more than a threshold period of time; generating, by the local computing unit, a braking command; and applying hydraulic force through electromechanical arrangement directly on each of a plurality of hydraulic lines of a braking system of the vehicle based on the braking command received from the local computing unit.

The Features and advantages of the subject matter hereof will become more apparent in light of the following detailed description of selected embodiments, as illustrated in the accompanying figures. As will be realized, the subject matter disclosed is capable of modifications in various respects, all without departing from the scope of the subject matter. Accordingly, the drawings and the description are to be regarded as illustrative.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, like features are identified by like reference numerals. Notably, the figures and examples are not meant to limit the scope of the present subject matter to a single embodiment, but other embodiments are possible by way of interchange of some or all of the described or illustrated elements and, further, wherein:

FIG. 1 is an example block diagram illustrating a redundant braking and safe parking system deployed on a car that is controlled by a remote pilot in accordance with an embodiment of the present disclosure.

FIG. 2 illustrates functional modules of a redundant braking and safe parking system in accordance with an embodiment of the present disclosure.

FIG. 3A illustrates an electromechanical arrangement for actuating a brake pedal in accordance with an embodiment of the present disclosure.

FIG. 3B illustrates an electromechanical arrangement for applying braking force directly on each braking line of a braking system in accordance with an embodiment of the present disclosure.

FIG. 4A is a block diagram illustrating an electromechanical arrangement using a pneumatic cylinder to actuate a brake pedal of the vehicle in accordance with an embodiment of the present disclosure.

FIG. 4B is a block diagram illustrating an electromechanical arrangement using a pneumatic cylinder to control each braking line of a braking system of the vehicle in accordance with an embodiment of the present disclosure.

FIG. 5A is a block diagram illustrating an electromechanical arrangement using an electronic actuator to actuate a brake pedal of the vehicle in accordance with an embodiment of the present disclosure.

FIG. 5B is a block diagram illustrating an electromechanical arrangement using an electronic actuator to control each braking line of a braking system of the vehicle in accordance with an embodiment of the present disclosure.

FIG. 6A is a block diagram illustrating an electromechanical arrangement using a hydraulic cylinder to actuate a brake pedal of the vehicle in accordance with an embodiment of the present disclosure.

FIG. 6B is a block diagram illustrating an electromechanical arrangement using a hydraulic cylinder to control each braking line of a braking system of the vehicle in accordance with an embodiment of the present disclosure.

FIG. 7A illustrates an example local computing unit that generates braking commands and steering commands in accordance with an embodiment of the present disclosure.

FIG. 7B illustrates an example of an opportunistic driving mode for driving a vehicle in accordance with an embodiment of the present disclosure.

FIG. 7C illustrates an example of a conservative driving mode in accordance with an embodiment of the present disclosure.

FIGS. 8A-8B are example processes for redundant braking in a remotely piloted vehicle in accordance with an embodiment of the present disclosure.

FIG. 9 illustrates an exemplary computer unit in which or with which embodiments of the present invention may be utilized.

FIG. 10 illustrates an example of a system for integration of a redundant braking system with onboard control systems of a vehicle.

### DETAILED DESCRIPTION

The detailed description set forth below in connection with the appended drawings is intended as a description of examples in which the presently disclosed subject matter can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed subject matter. However, it will be apparent to those skilled in the art that the presently disclosed process may be practiced without these specific details. In some instances, well-known structures and devices are shown in block diagram form in order to avoid obscuring the concepts of the presently disclosed method and system.

Examples of the presently disclosed subject matter include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and human operators.

Examples of the presently disclosed subject matter may be provided as a computer program product, which may include a machine-readable, non-transitory storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various approaches described herein may be practiced by combining one or more machine-readable storage media containing the code according to the present invention with appropriate standard computer hardware to execute the code contained therein. An apparatus for practicing various examples of the presently disclosed subject matter may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an example,” “according to one example,” and the like generally mean the particular feature, structure, or characteristic following the phrase is included in at least one example of the present disclosure and may be included in more than one example of the present disclosure. Importantly, such phrases do not necessarily refer to the same example.

It will be appreciated by those of ordinary skill in the art that the diagrams, schematics, illustrations, and the like represent conceptual views or processes illustrating the presently disclosed subject matter. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing the disclosed subject matter. Those of ordinary skill in the art further understand that the exemplary hardware, software, processes, methods, and/or operating systems described herein are for illustrative purposes and, thus, are not intended to be limited to any particular name.

A vehicle described herein may be a car, a motorbike, a transport vehicle, a public transport vehicle, or the like.

Embodiments of the present disclosure generally may provide a system and method for redundant braking and safe parking of a remotely piloted vehicle. A remotely piloted vehicle may have multiple sensors (e.g., cameras or other appropriate sensors) to gather environmental data from around the vehicle or gathering state data of the vehicle itself. The remotely piloted vehicle may have one or more communication interfaces for sending these data to a remote pilot. The remotely piloted vehicle may receive driving commands from the remote pilot. The remote pilot, at a remote pilot station or remote pilot terminal (also referred to as remote pilot control unit), may receive environmental data along with other in-vehicle data and may control the vehicle from the remote pilot control unit. The remote pilot may receive the data as rendered on display screens at a remote pilot control unit in such a manner as to make the remote pilot feel that he/she is in the vehicle. The remote pilot may get a view of the vehicle and environment around the vehicle through a graphical user interface (GUI). The GUI may allow the remote pilot to switch to different modes or views. The remote pilot may be presented with appropriate information based on a display mode selected from multiple information display modes based on the driving mode selected by the driver. The information display modes may include a reverse driving mode, a turning mode, a drive mode, a hill climb mode, etc.

The vehicle may include an onboard remote piloting facilitation system that may receive commands from the remote pilot through a remote communication interface and may send a received command to different drive-by-wire components of the vehicle. The onboard remote piloting facilitation system may have a local bus communication interface with a central vehicle control unit. Throughout this description, unless specifically mentioned otherwise, a pilot or driver refers to a remote driver. Similarly, a vehicle refers to a remotely piloted vehicle.

The remote pilot may have a simulator interface replicating actual driving conditions including a dashboard, etc. of the vehicle and may have a steering and brake pedal or brake lever that the remote pilot can use to provide inputs for generation of control commands to control the vehicle.

As may be appreciated, if a network connection between the remotely piloted vehicle and the remote pilot fails or degrades, the amount and/or quality of data communicated to the remote pilot may reduce the ability of the remote pilot to operate the vehicle remotely. In such instances, a redundant braking and safe parking system may be provided to assist in rendering the vehicle safe in the event of a detected network failure. While referred to as a redundant braking and safe parking system, it may be appreciated that such a system need not necessarily control both braking and steering. That is, such a system may only brake to render the vehicle save, may only steer to render the vehicle safe, or may control braking and steering (and/or other controls of the vehicle such as lighting or the like) to render the vehicle safe.

In relation to a redundant braking and safe parking system, a monitor system may be provided to monitor a network status to determine whether a network failure has occurred such that some interventional control is needed to render the vehicle safe. Accordingly, certain aspects of the present disclosure relates to hardware, software, and/or firmware that may be used to determine if a network failure has occurred.

Furthermore, the monitor system may, in the event of a detected network failure, alert a local control system to take local action (i.e., without input from a remote pilot) to render the vehicle safe. As will be described in greater detail below, such local control systems may include an electromechanical arrangement to locally control a vehicle. For instance, this may include an arrangement that is adapted to physically manipulate existing components of the vehicle such as by actuating a brake pedal, moving a steering wheel, or the like. In other examples, the electromechanical arrangement may be partially integrated into vehicle systems such that conventional driver controls are not directly manipulated, but rather the electromechanical arrangement applies physical inputs into existing vehicle systems (e.g., a pressure regulator integrated into the vehicle's braking system may apply braking pressure directly to the braking system without actuating the brake pedal). Further still, electronic arrangements may be provided that integrate into existing electromechanical systems. For instance, if a vehicle is equipped with brake-by-wire or steer-by-wire technologies, the local control system may provide direct electronic communication to an existing controller of such systems at the vehicle to control integrated electromechanical devices of the vehicle.

In an example, the remotely piloted vehicle may include a local computing unit configured to perform certain features, such as braking and safe parking, in a scenario in which the vehicle is not able to communicate and receive commands from the remote pilot. The onboard remote piloting facilitation system may include a main computing unit that receives data and commands from the remote pilot and coordinates performance of remote pilot commands at the vehicle when in connected mode. The main computing unit may collect environmental data from vehicle sensors and may receive commands from a remote pilot to operate the vehicle.

In relation to aspects of the monitor system, the local computing unit may receive real-time synchronization (sync) data from the main computing unit. The sync data includes sensory data collected by onboard vehicle sensors and imaging devices, analytical results from one or more cloud service providers, and/or commands received from the remote pilot device. The local computing unit may continually or periodically check a connection with the remote pilot device using a heartbeat signal. If the heartbeat signal is not received for more than a threshold period of time, the local computing unit may conclude that a network failure has occurred. The local computing unit, upon the detection of a network failure, may analyze last sync data and issue control commands to the local control system to control the vehicle without remote pilot intervention. In an example, the local computing unit can issue braking and/or steering commands to the vehicle control unit to steer and/or park the vehicle at a safe location. The local computing unit keeps syncing with the main computing unit to receive the latest environmental data and operating commands but may not take any action until the vehicle is in communication with the remote pilot terminal. In this regard, the local computing unit may provide a fail-safe such that in the event of a network failure, the local computing unit may at least control the vehicle in a manner that safely stops the vehicle in a safe location.

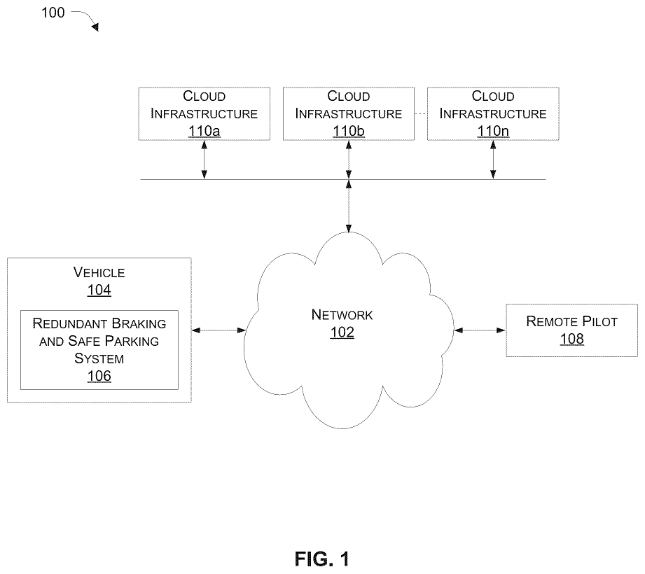

FIG. 1 is a block diagram illustrating an example redundant braking and safe parking system 100 deployable on a vehicle controlled by a remote pilot. As shown in FIG. 1, a vehicle 104 may be piloted by a remote pilot 108 connected through a network 102. The network may be a wireless communication network, including 3G, 4G, 5G, and/or any other future generation wireless communication network. Vehicle 104 may include a remote pilot facilitation system configured to receive commands from the remote pilot 108 and operate the vehicle accordingly. The remote pilot facilitation system may collect data from the onboard vehicle system and vehicle operation parameters and share the collected data with the remote pilot 108. The remote pilot facilitation system may collect sensor data, send the data for processing by cloud infrastructure 110a, 110b, . . . 110n, and receive the processed data. For example, the sensory data, which may include images, video, and/or audio signals captured by onboard cameras, can be sent to the cloud infrastructure for faster processing and object identification. Vehicle 104 may receive map data and live location updates from a location service, and other associated metadata from third-party services. The data collected by the onboard sensors, analysis results received from one or more service providers, and/or driving instructions received by the remote pilot may collectively assist the remote pilot facilitation system drive the vehicle 104 safely.

In a normal operating mode, where vehicle 104 is connected with the remote pilot 108, vehicle 104 may be steered and controlled directly by control commands received from the remote pilot 108. However, as the system may rely on network 102 for receiving control commands (e.g., steering commands, braking commands, acceleration commands, etc.) from remote pilot 108, any network failure or delay in receiving the control commands may reduce the ability to remotely control the vehicle operation in a reliable manner.

Accordingly, vehicle 104 may have an onboard redundant braking and safe parking system 106 that may include a local computing unit and an arrangement configured to execute a local action such as activating a braking system or actuating the brake pedal of the vehicle when a network failure is detected. Specifically, the local computing unit may generate and execute the local action in the absence of any remote instruction or guidance. The local computing unit may be configured to monitor the operation of the vehicle 104 and/or the redundant braking and safe parking system 106 to determine if the vehicle 104 is being piloted by the remote pilot 108.

For example, the local computing unit may receive sync data from the main computing unit and may store the sync data in a buffer. The sync data in the buffer may be updated with the latest sync data received from the main computing unit (e.g., the buffer may be a circular buffer that is continually overwritten with fresh sync data). The local computing unit monitors the status of the network connection between the vehicle 104 and the remote pilot 108. The local computing unit may generate a control command (e.g., a braking command, steering command, etc.) based on analysis of the sync data in the buffer if network failure is detected. That is, the local computing unit may maintain a buffer with recent conditions, which may be utilized in the event that a network failure is detected to allow the local computing unit to safely pilot the vehicle 104 to a safe location.

In an example, a remote pilot control unit can also send a reset command to system 106 indicating a fixed time duration for which the driving directions remain valid. System 106 may not generate a control command, even if the vehicle has temporarily lost connectivity. Rather, the local computing unit may drive the vehicle based on the last received instruction until the fixed time duration has lapsed and the reset command is not received. The reset command resets a clock or a delay-circuit that delays the generation of a control command by the system 106 for the fixed time duration. If the reset command with a new fixed time duration is received, the clock to trigger the control command is reset and the control command generation decision (e.g., without reference to a received instruction) can be delayed. The reset command can also be generated by the main computing unit based on the collected and last instruction received from the remote pilot 108. If the reset command is not received or generated locally, system 106 may generate the control command. While referred to as a fixed time duration, it may be appreciated that the fixed time duration may vary based on vehicle conditions (e.g., speed) or environmental conditions (e.g., measured congestion, weather, etc.).

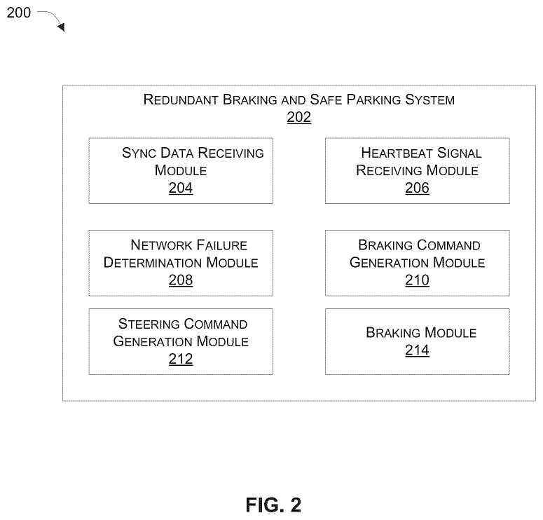

FIG. 2 illustrates functional modules of a redundant braking and safe parking system in accordance with an example of the present disclosure. The redundant braking and safe parking system 202 may include a sync data receiving module 204 configured at a local computing unit to receive sync data from a main computing unit. The sync data is received in an almost real-time basis and may include environmental data collected by different onboard sensors (e.g., imaging sensor, LADAR, LIDAR, Infrared, etc.); vehicle operating parameters (e.g., speed, traction, driving mode, terrain information, etc.); navigational data; and instructions received from the remote pilot. In an example, the main computing unit may be an onboard computing unit at the vehicle and hence the local computing unit may be in communication with the main computing unit using a data bus. In another example, the main computing unit may be a cloud service that can collect data from vehicles to facilitate remote piloting of the vehicle. As such, a cloud-based main computing unit may interact with the local computing unit through a wireless communication medium.

The system may include a heartbeat signal receiving module 206 configured to check the communication between the vehicle and the remote pilot unit and a network failure determination module 208 configured to determine network failure if the heartbeat signal is not received for a given time interval (e.g., 2 seconds, 50 microseconds, etc.). The time interval may be fixed or dynamic. The heartbeat signal receiving module 206 may be configured at the local computing unit to send and receive a pulse signal, also referred to as a keep-alive signal or a heartbeat signal, to the remote pilot unit. The heartbeat signal receiving module can also be configured to be executed at the main computing unit if the main computing unit is located onboard the vehicle. That is, the heartbeat signal may be configured to transit a network between modules monitoring for the presence of the heartbeat signal, thus providing an indication of network connectivity between the components. The network failure determination module 208 may conclude a network failure has occurred if the heartbeat signal is not received for a threshold period of time or if the available bandwidth received by the vehicle is less than a predetermined minimum bandwidth (e.g., which may correspond to a given bandwidth to provide for the safe operation of the remotely piloted vehicle). In an embodiment, the network failure determination module 208 may determine network failure if the vehicle communication does not meet the predetermined minimum bandwidth. In an example, the predetermined minimum bandwidth may be determined based on a speed of the vehicle and/or the mode of operation of the vehicle.

For better reliability of communication between the local computing unit, main computing unit, and the remote pilot unit, the vehicle may use services of multiple service providers. In case of service unavailability by a first service provider network, the vehicle may use a second service provider network. The heartbeat signal receiving module 206 may attempt to send and receive the heartbeat signal using a best opportunity approach to connect and check the communication link between the vehicle and the remote pilot. The network failure determination module 208 may determine a network failure if it does not receive a heartbeat signal for the threshold period of time using any of the plurality of service provider networks.

The redundant braking and safe parking system 202 may include a braking command generation module 210 configured at the local computing unit to generate a braking command in the event of a determination of network failure. The braking command generation module 210 may analyze the last received sync data and may generate a braking command accordingly in the event of a determination of network failure. In an example, the braking command generation module 210 may determine an amount of braking pressure to be applied or may determine a braking time to safely stop the vehicle. The braking command generation module 210 may generate the braking command to bring the vehicle smoothly to a stop as quickly as safely possible. Braking command generation module 210 may, based on an analysis of the last sync data, delay the braking command if the vehicle is operating in an environment in which safe continuation of the current condition is possible (e.g., running on a straight road without any traffic). In turn, the braking command generation module 210 may wait to determine if the communication signal is restored. However, if the heartbeat signal is not received even after a second threshold period of time, the braking command generation module 210 may generate the braking command to stop the vehicle.

System 202 may further include a steering command generation module 212 configured at the local computing unit to generate a steering command providing steering direction to the vehicle control unit. The steering command generation module 212 may use the last sync data to identify the surrounding vehicle, road conditions, etc., and may identify a suitable spot for safely stopping the vehicle. Module 212 may analyze lane discipline rules, the status of other vehicles and may generate the steering command to drive the vehicle for parking at a safe spot. Module 212 may refer to navigational data to select safe parking spots. In addition, the module 212 may follow the same protocol for delaying generation of a control command in the event that it is determined that continuation of a prior operation in the absence of a remote pilot command allows for safe operation of the vehicle.

System 202 may include a braking module 214 configured to receive the braking command and to control application of the brakes of the vehicle. As described in greater detail below, the braking module 214 may use an electromechanical, hydraulic, pneumatic, and/or other type of arrangement to actuate (e.g., push, pull, or otherwise move) a brake pedal of the vehicle. The electromechanical arrangement for actuating the brake pedal may include a smart solenoid, an air compressor, a pressure tank, a pneumatic cylinder, and a link rod attached with the brake pedal. The smart solenoid may activate the pneumatic cylinder based on the braking command received from the first computer to cause the link rod to actuate the brake pedal.

In another alternative example, the electromechanical arrangement may include an electric actuator configured to receive the braking command and actuate the brake pedal based on a braking command. In yet another alternative embodiment, the electromechanical arrangement may comprise a pressure supply unit configured to control a hydraulic cylinder to actuate the brake pedal based on the braking command received from the local computing unit.

In still other examples, the braking module 214 may provide for direct application of pressure to a braking system of the vehicle. That is, the braking module 214 may interface with the braking system of the vehicle to apply braking force (e.g., via hydraulic pressure) directly to the braking system (e.g., without having to actuate the brake pedal of the vehicle). For example, the system 202 may include a braking module 214 configured to receive the braking command and control an electromechanical arrangement to control each of the hydraulic braking lines of a preinstalled vehicle braking system. In an example, the electromechanical arrangement may apply fluid pressure on each of the plurality of hydraulic brake lines of the braking system using a smart solenoid, an air compressor, a pressure tank, a pneumatic cylinder, and/or a brake booster. The smart solenoid may activate the pneumatic cylinder based on the braking command received from the local computing unit to generate a mechanical force that may actuate a linear piston of the pneumatic cylinder, wherein the piston is linked to a brake booster that converts mechanical force to fluid force. The brake booster may apply fluid force directly on each of the hydraulic brake lines to quickly stop the vehicle. The brake booster may have a set of fluid pipes, each connected to a respective hydraulic line of the braking system of the vehicle. In an example, the brake booster may include a microcontroller that can receive speed data and wheel position data to apply a variable fluid pressure on each of the hydraulic lines to safely stop the vehicle.

In still another embodiment, the braking module 214 may include an electronic controller executing software and/or firmware to generate electronic signals that are provided to a vehicle control system (e.g., a brake-by-wire or steer-by-wire system). In this regard, the braking module 214 may electronically communicate a control signal directly to the vehicle for use of existing vehicle controllers to effectuate the commands. In this situation, feedback may be provided from the vehicle to assist in modulation of the control signals, as will be described in greater detail below.

The redundant braking and safe parking system 202 may include a timer circuit that can trigger the braking command if the heartbeat signal is not received for a second threshold period of time as discussed above. The timer circuit can reset itself on receipt of the heartbeat signal. The timing circuit may allow the vehicle to be operated in either a conservative mode or an opportunistic mode. In conservative mode, the vehicle may be brought to a safe condition without delay from detection of a non-receipt of the heartbeat signal. In an opportunistic mode, the redundant braking system may include a delay circuit that may cause the electromechanical components to delay the braking for a fixed duration. The local computing unit may send a reset signal to the delay circuit if it is determined that the vehicle can be driven safely for the fixed duration, even if the vehicle has detected a network failure. The determination that the vehicle can be driven safely for the fixed duration can be performed by the local computing unit or the reset signal containing the fixed duration can be received from the main computing unit or the remote pilot control unit.

System 202 may further include a driver presence detection module configured to detect if there is an onboard driver in the vehicle, and a manual takeover alert module configured to alert the user to take manual control of the vehicle if network failure is detected. In an embodiment, system 202 allows the configuration of priority between the remote pilot and the onboard driver. In an embodiment, the local computing unit may also receive input related to the presence of a physical driver in the vehicle. The onboard driver presence detection module, which may be a camera-based module or other sensors, can detect if a driver is present on the driving seat and share the driver presence information to the local computing unit. System 202 may allow the local computing unit to apply the brake only when the physical driver is not present in the vehicle, and a network failure is detected.

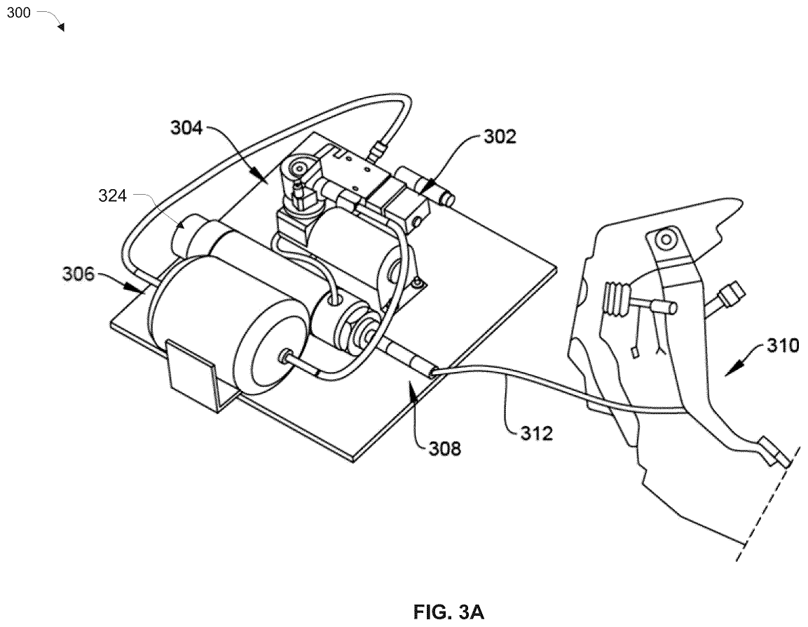

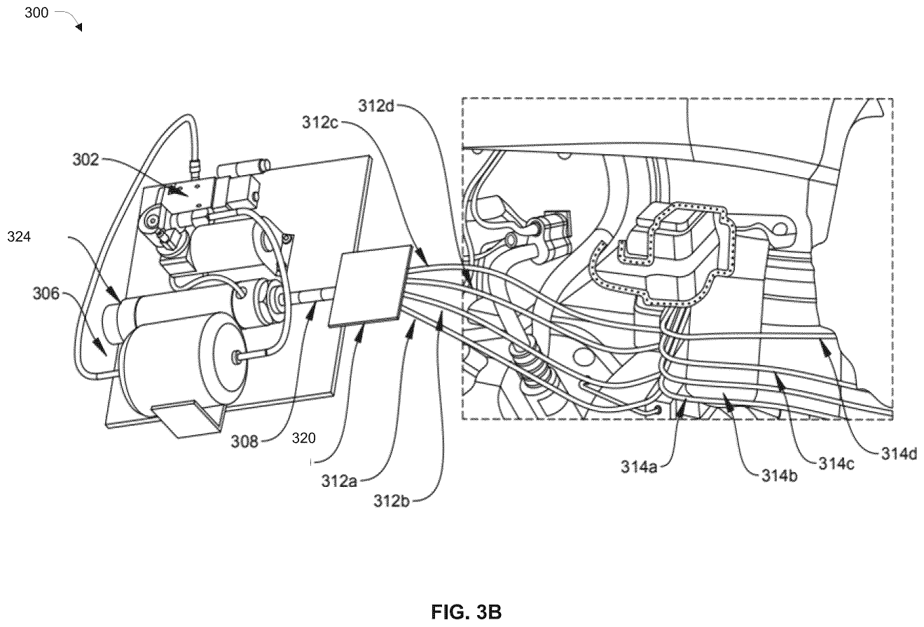

FIG. 3A illustrates an electromechanical arrangement for actuating a brake pedal in accordance with an example of the present disclosure. The redundant braking system may include braking components that actuate a brake pedal 310 of the vehicle based on the braking command received from the local computing unit. The braking components may include a smart solenoid 302, an air cylinder 324, an air compressor 304, and a pressure tank 306, wherein the solenoid actuates a linear piston 308 attached through a cable 312 to the brake pedal 310 based on the braking command received from the local computing unit. The smart solenoid may receive the braking command in digital form and activates the air cylinder 324 to move the cable 312 an appropriate magnitude and speed to apply the braking in proportion to the braking command. As one will appreciate, actuating the brake pedal 310 will cause the braking systems of the vehicle to activate. The smart solenoid dynamically varies the pressure to actuate the pedal relative to the vehicle speed to ensure smooth braking.

The proposed system can be a retrofitted system that may not require changes in the internal braking systems of the vehicle. The proposed redundant braking system including the electromechanical arrangement can be added and removed from the vehicle without any adverse effect on the normal operation of the vehicle. The proposed arrangement can be used for light to medium-duty vehicles.

FIG. 3B illustrates an electromechanical arrangement for applying braking pressure directly on each braking line of a braking system in accordance with an example of the present disclosure. In an example, the redundant braking system may include braking components that apply braking pressure directly on each braking line 314a-d of a vehicle braking system. The system may apply variable braking pressure on each braking line (e.g., braking lines 314a-d) to control the stable braking of each wheel of the vehicle.

The braking components may include a smart solenoid 302, an air cylinder 324, an air compressor 304, and a pressure tank 306, wherein the solenoid actuates a linear piston 308 attached to a brake booster 320 based on the braking command received from the local computing unit. The smart solenoid may receive the braking command in digital form and may activate the air cylinder 324 to actuate piston 308 attached with the brake booster at an appropriate level. The brake booster 320 may apply additional logic to convert the mechanical actuation into hydraulic pressure that the brake booster can apply through the connecting cables 312a-d respectively to braking lines 314a-d. In an embodiment, connecting cables 312a-d may be fluid pipes that can apply hydraulic pressure directly to each of the braking lines 314a-d.

The proposed system can be a retrofitted system that requires minimal changes in the internal braking systems of the vehicle. The hydraulic braking lines 314a-d can be connected to the connecting cables 312a-d. The proposed redundant braking system including the electromechanical arrangement can be added and removed from the vehicle without any adverse effect on the normal operation of the vehicle. The proposed arrangement can be used for light to medium-duty vehicles.

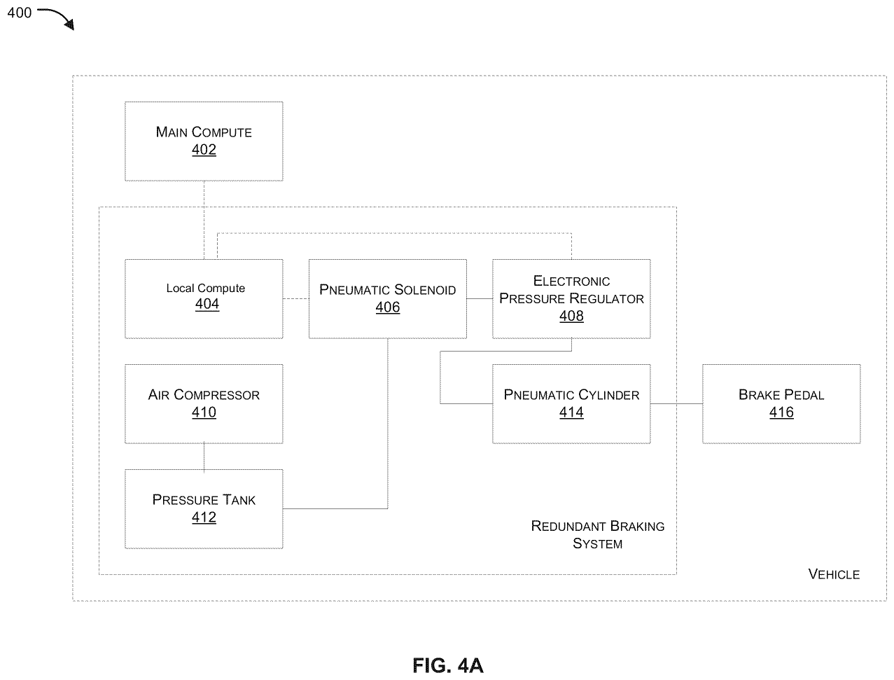

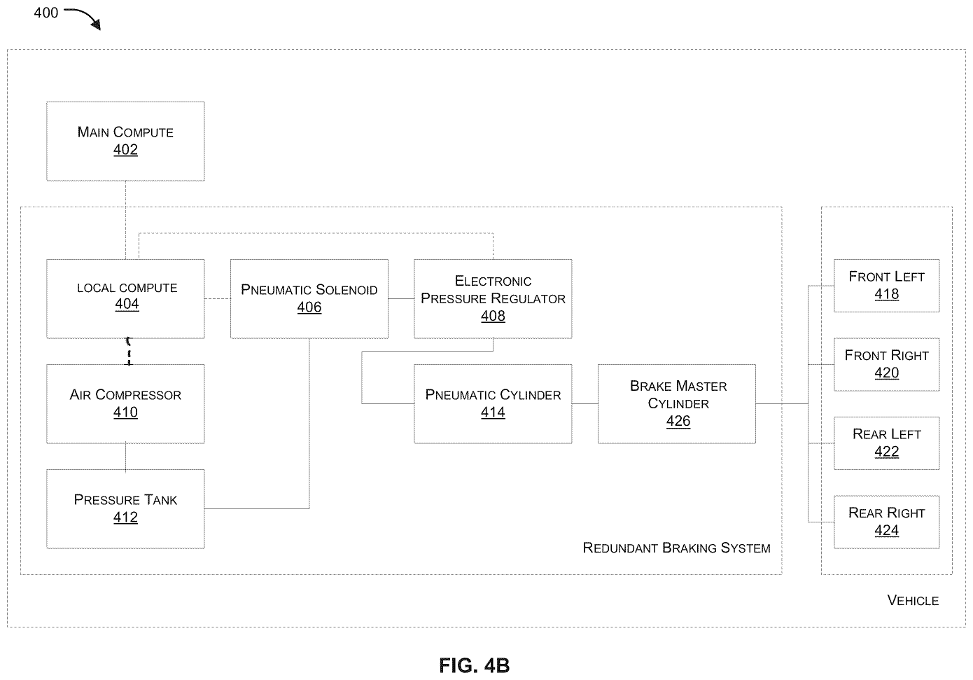

FIG. 4A is a block diagram illustrating electromechanical arrangement using a pneumatic cylinder to actuate a brake pedal of the vehicle in accordance with an embodiment of the present disclosure depicted in FIG. 3A. The dotted lines in FIGS. 4A-6B represent communication links and the solid lines represent a mechanical connection between the components. As shown in FIG. 4A, a main computing unit 402 (may be onboard the vehicle. The main computing unit 402 may share sync data with the local computing unit 404 that in turn analyzes the data in absence of network connection with the remote pilot or when the physical drive is not present in the vehicle. The local computing unit 404 may send a braking command to a pneumatic solenoid 406 and an electronic pressure regulator 408. The electronic pressure regulator 408 regulates the pneumatic pressure that is applied on a pneumatic cylinder 414 that actuates the brake pedal 416 of the vehicle. The pneumatic solenoid controls the flow of air or gas from pressure tank 412 to control the movement of pneumatic cylinder 414. The stroke of the piston of cylinder 414 may actuate the brake pedal 416 to apply a brake on the vehicle. A spring force may help to release the brake. The pressure tank 412 maintains air pressure at a defined level with help of air compressor 410. A pressure sensor attached with pressure tank 412 may trigger the air compressor 410 to supply compressed air to pressure tank 412.

FIG. 4B is a block diagram illustrating electromechanical arrangement using a pneumatic cylinder to control each braking line of a braking system of the vehicle in accordance with an embodiment of the present disclosure as depicted in FIG. 3B. As shown in FIG. 4B, a main computing unit 402 may be onboard the vehicle. The main computing unit 402 may share sync data with the local computing unit 404 that in turn analyzes the data in absence of network connection with the remote pilot or when an on-board driver is not present in the vehicle. The local computing unit 404 may send a braking command to a pneumatic solenoid 406 and an electronic pressure regulator 408. The electronic pressure regulator 408 regulates the pneumatic pressure that is applied on a pneumatic cylinder 414 that actuates the brake master cylinder 426, which in turn applies braking pressure on each of the braking lines controlling different wheels (e.g. front left wheel 418, front right wheel 420, rear left 422, and rear right 424) of the vehicle. The brake master cylinder 426 may be a brake booster that can convert the mechanical actuation into hydraulic brake pressure. The pneumatic solenoid controls the flow of air or gas from pressure tank 412 to control the movement of pneumatic cylinder 414. The stroke of the piston of cylinder 414 may actuate brake master cylinder 426 to apply a brake to each braking line of the vehicle. A spring force may help to release the brake. The pressure tank 412 maintains air pressure at a defined level with help of air compressor 410. A pressure sensor attached with pressure tank 412 may trigger the air compressor 410 to supply compressed air to pressure tank 412.

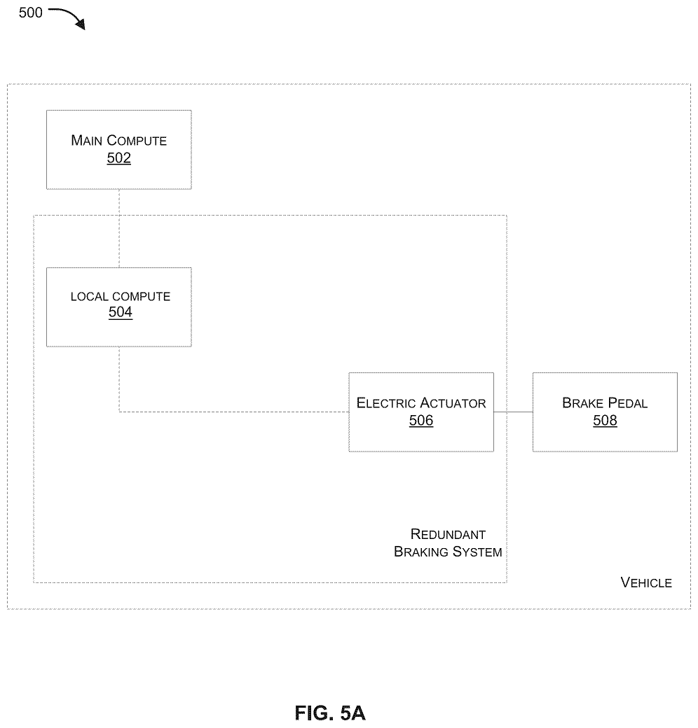

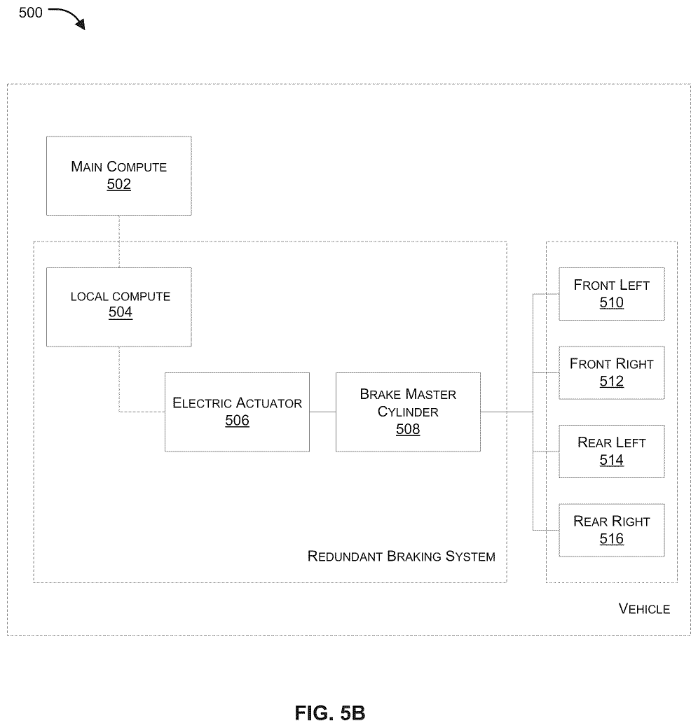

FIG. 5A is a block diagram illustrating an electromechanical arrangement using an electronic actuator to actuate a brake pedal of a vehicle in accordance with an example of the present disclosure. As shown in FIG. 5A, system 202 may use an electric actuator 506 to actuate the brake pedal 508 of the vehicle. In an example, a main computing unit 502 may send the sync data to a local computing unit 504. The local computing unit 504 may detect a network failure and may generate a braking command and send it to an electric actuator 506 which may actuate the brake pedal 508 attached through a cable. The electric actuator 506 may actuate the brake pedal 508 in proportion to the braking force indicator provided in the braking command. The electric actuator 506 creates movement of a load (e.g., brake pedal 508) using an electric motor. The electric motor may generate the necessary force required to stop the vehicle. The electric actuator 506 may be a linear actuator.

FIG. 5B is a block diagram illustrating electromechanical arrangement using an electronic actuator to control each braking line of a braking system in accordance with an embodiment of the present disclosure. As shown in FIG. 5B, system 202 may use an electric actuator 506 to actuate a piston attached with a brake master cylinder 508, which can apply braking pressure on braking lines controlling the different wheels (e.g., front left wheel 510, front right wheel 512, rear left wheel 514, and rear right wheel 516) of the vehicle. In an embodiment, a main computing unit 502 may send the sync data to a local computing unit 504. The local computing unit 504 may detect the network failure may generate a braking command and send it to an electric actuator 506 which may cause the braking master cylinder to control braking pressure that is applied to each of the braking lines. The electric actuator 506 may actuate the piston attached with the brake master cylinder 508 in proportion to the braking force indicator provided in the braking command. The electric motor may generate force to stop the vehicle. The electric actuator 506 may be a linear actuator.

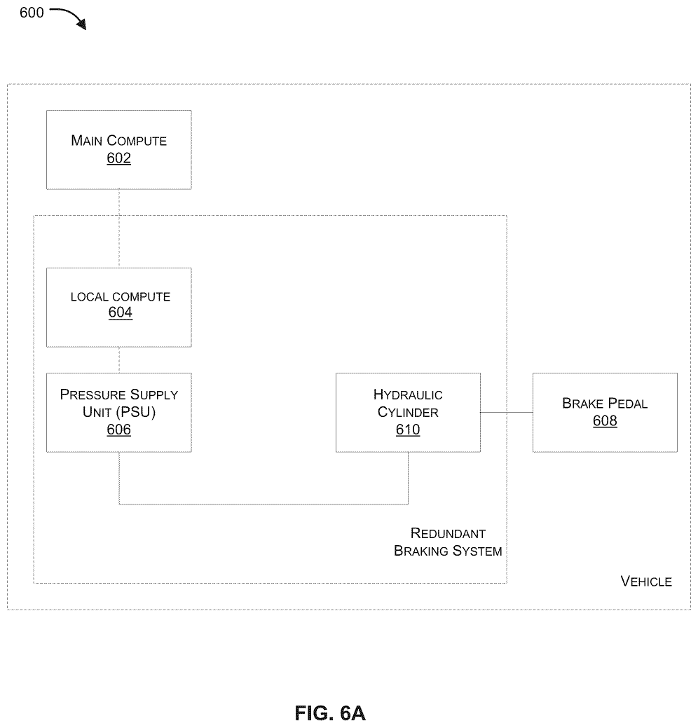

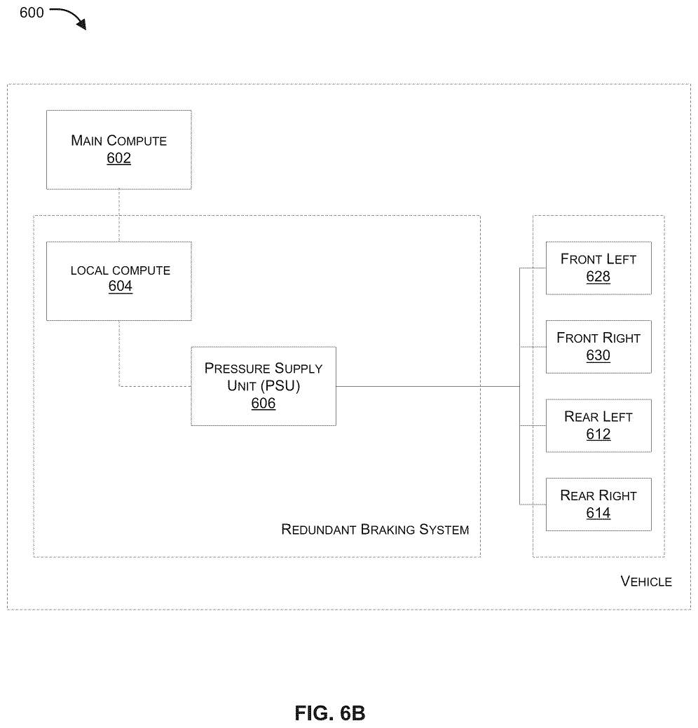

FIG. 6A is a block diagram illustrating electromechanical arrangement using a hydraulic cylinder to actuate a brake pedal of the vehicle in accordance with an embodiment of the present disclosure. As shown in FIG. 6A, system 202 may use hydraulic cylinder 610 to actuate the brake pedal 608 of the vehicle. In an example, a main computing unit 602 may keep sharing the sync data with a local computing unit 604, which on detection of the network failure analyzes the last sync data and generates a braking command. The local computing unit 604 may send the braking command to a pressure supply unit (PSU) 606, which regulates the fluid pressure applied by a hydraulic cylinder 610 of brake pedal 608. The pressure supply unit 606 regulates the fluid pressure based on the braking force indicator received as part of the braking command.

FIG. 6B is a block diagram illustrating electromechanical arrangement using a hydraulic cylinder to control each braking line of a braking system of the vehicle in accordance with an embodiment of the present disclosure. As shown in FIG. 6B, system 202 may use a pressure supply unit (PSU) 606 to apply braking pressure on braking lines of different wheels (e.g., front left wheel 628, front right wheel 630, rear left wheel 612, and rear right wheel 614) of the vehicle. In an example, a main computing unit 602 may keep sharing the sync data with a local computing unit 604, which on detection of the network failure analyzes the last sync data and generates a braking command. The local computing unit 604 may send the braking command to a pressure supply unit (PSU) 606, which regulates the fluid pressure applied to braking lines. The pressure supply unit 606 regulates the fluid pressure based on the braking force indicator received as part of the braking command.

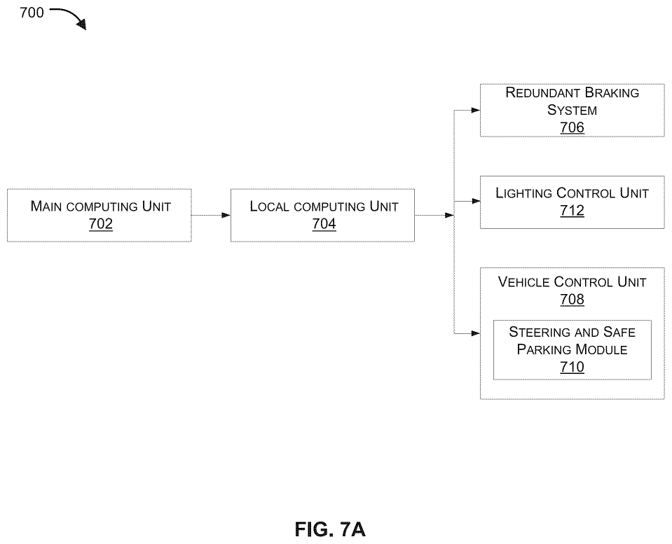

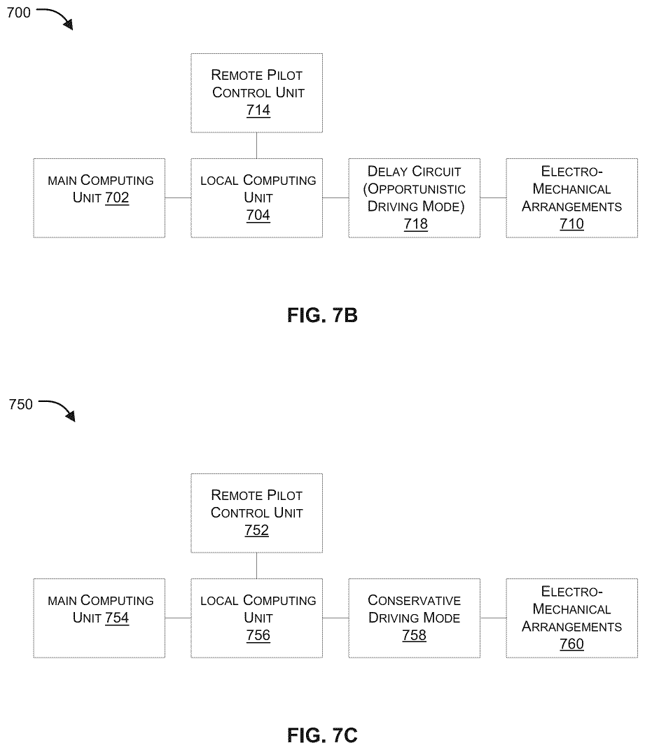

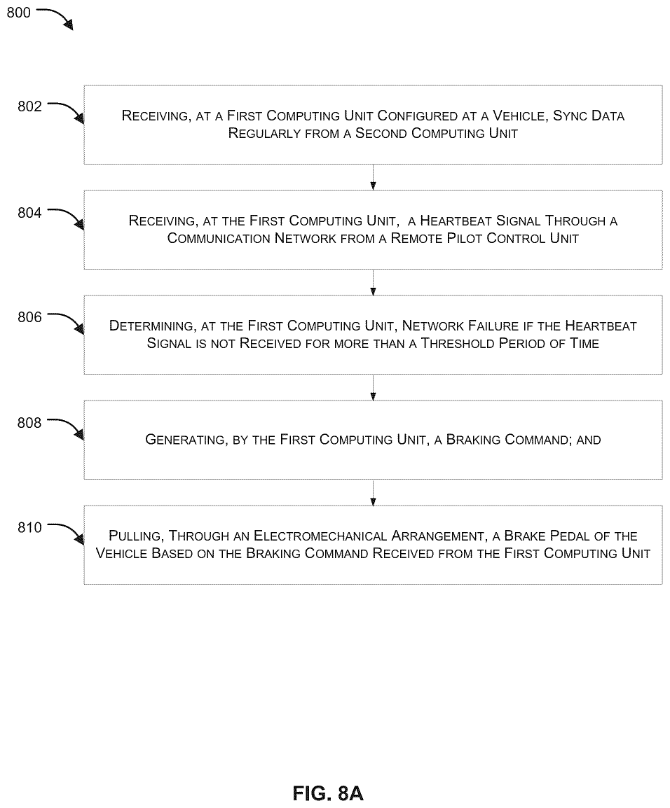

FIG. 7A illustrates an example system 700 that may generate a control command (e.g., braking commands and/or steering commands) in accordance with an example of the present disclosure. As shown in FIG. 7A, a local computing unit 704 may analyze the last sync data received from a main computing unit 702 and generate one or more control commands for redundant braking system 706 and/or steering commands for the vehicle control unit 708. The local computing unit 704, on detection of a network failure, analyzes the last sync data to determine the need to generate a braking command and/or steering command. Local computing unit 704 determines the need for braking commands based on multiple factors including but not limited to vehicle speed, turns ahead, environmental data indicating a crowded area, approaching vehicle data, adjacent vehicle data, objects in front of the vehicle, and last instructions received from the remote pilot.

In an example, local computing unit 704 may also use machine learning models to analyze and predict the next immediate actions for the next few seconds or fractions of a second in a sequence of last instructions received from the remote pilot. If the machine learning model predicts the vehicle would be safe for driving for some time, local computing unit 704 may not trigger the braking command. Similarly, if local computing unit 704 predicts that the vehicle is safe to operate without changing lanes for some time, local computing unit 704 may not generate the steering command. In an example, local computing unit 704 may generate a steering command for switching the lane from a fast-moving lane to a slow-moving lane and wait for a second threshold period of time to generate a steering command and braking command to completely stop the vehicle at a safe spot. The system may try to find a suitable safe parking spot nearby and park the vehicle at the safe parking spot. However, if a safe parking spot is not available within a safe driving distance, the vehicle may be stopped in a slow-moving lane, shoulder, or other safe location. Local computing unit 704 may send instructions to a lighting control unit 712 to indicate lane-changing and braking events, depending on the braking command and steering command generated.

A steering and safe parking module 710 of the vehicle control unit 708 may receive the steering command and steer the vehicle to stop at a safe parking spot. The steering command provides ordinates and step by step direction for stopping the vehicle at a safe spot. Based on the steering command received from local computing unit 704, the steering and safe parking module 710 may change the lane and work in coordination with the redundant braking system 706 to stop the vehicle.

FIG. 7B illustrates an example of an opportunistic driving mode for driving a vehicle in accordance with an embodiment of the present disclosure. As shown in FIG. 7B, the local computing unit 704 may receive input from the main computing unit 702 and the heartbeat signal from the remote pilot control unit 714. The local computing unit 704 may generate a braking command based on the inputs received from the main computing unit 702, which provides data collected from a vehicle and analyzed inputs if the heartbeat signal is not received from the remote pilot control unit 714 for more than a threshold period of time. In an embodiment, the local computing unit 704 may also receive a delay circuit reset command from either the main computing unit 702, local computing unit 704 or the remote pilot control unit 714. The delay circuit reset command provides a fixed time duration for which the vehicle can be driven safely without applying the brake. As noted above, while referred to as a “fixed time,” this may be a predetermined time that may vary based on conditions detected by the vehicle. The redundant braking system 202 may include a delay circuit 718 or a clock that can be updated based on the reset command. The local computing unit 704 may not issue a braking command to the electromechanical arrangements 760 until the expiry of the fixed time duration. If the fixed time duration has expired, the local computing unit 704 may check the heartbeat signal, and if the heartbeat signal was not received from within a given threshold period, the local computing unit 704 may generate the braking command send the braking command to activate electromechanical arrangements 760. In the embodiment, the local computing unit 704 may generate the breaking command if the heartbeat signal is not received for the threshold period of time and send the braking command to the delay circuit 718, which can forward the braking command to activate the mechanical arrangements to apply brake only if the fixed duration provided in the reset command has expired.

In an embodiment, the system may allow the remote driver or onboard driver to select an opportunistic driving mode (e.g., according to FIG. 7C) or a conservative driving mode (e.g., according to FIG. 7B) for applying redundant braking. Arrangement of FIG. 7A enables opportunistic driving mode, where the vehicle is not driven for a few more seconds or a fraction of seconds with respect to conservative driving mode, in which the braking command is issued as soon as the network failure is detected.

FIG. 7C illustrates an example conservative driving module in accordance with an embodiment of the present disclosure. As shown in FIG. 7C, a local computing unit 756 may receive the sync data from the main computing unit 754 and generate a braking command in absence of a heartbeat signal from the remote pilot control unit 752. The local computing unit 756 issues the braking command if the heartbeat signal is not received for the threshold period of time and passes the braking command without any delay to activate the electromechanical arrangements to apply the brake. In conservative driving mode 758, the braking commands are generated as soon as the network failure is detected, even if the system predicts that the vehicle can be driven safely for some time.

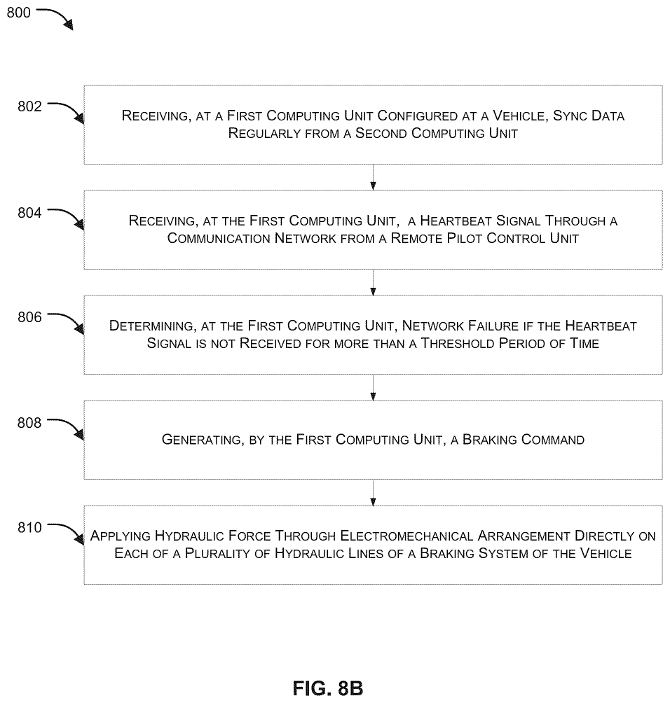

FIG. 8A is an example process for redundant braking in a remotely piloted vehicle in accordance with an example of the present disclosure. Process 800 for redundant braking of remotely piloted vehicles may include steps coded in form of executable instructions to be executed by a local computing unit to activate electromechanical arrangement to actuate the brake pedal of a vehicle. Process 800 includes steps of receiving sync data regularly from a main computing unit, as shown at block 802, receiving a heartbeat signal through a communication network from a remote pilot control unit, as shown in block 804, and determining network failure if the heartbeat signal is not received for more than a threshold period of time, as shown at block 806. The process 800 further includes steps of generating a braking command, as shown at block 808 and actuating through an electromechanical arrangement, a brake pedal of the vehicle based on the braking command received from the local computing unit, as shown at block 810. Process 800 may further include steps of analyzing the sync data to generate steering command and steering the vehicle to stop at a safe parking spot.

FIG. 8B is an example process for redundant braking in a remotely piloted vehicle in accordance with an example of the present disclosure. Process 800 for redundant braking of remotely piloted vehicles includes steps coded in form of executable instructions to be executed by a local computing unit to activate electromechanical arrangement to apply braking pressure of braking lines of a vehicle. Process 800 includes steps of receiving sync data regularly from a main computing unit, as shown at block 802, receiving a heartbeat signal through a communication network from a remote pilot control unit, as shown in block 804, and determining network failure if the heartbeat signal is not received for more than a threshold period of time, as shown at block 806. Process 800 further includes steps of generating a braking command, as shown at block 808, and applying hydraulic force through electromechanical arrangement directly on each of a plurality of hydraulic lines of a braking system of the vehicle as shown at block 810. Process 800 may further include steps of analyzing the sync data to generate steering command and steering the vehicle to stop at a safe parking spot.

Throughout the specification, the local computing unit is indicated to take the decision and generate the braking command and steering command when a network failure is detected. However, one skilled in the art will appreciate that all or parts of the functionalities of the local computing unit can also be performed by the main computing unit.

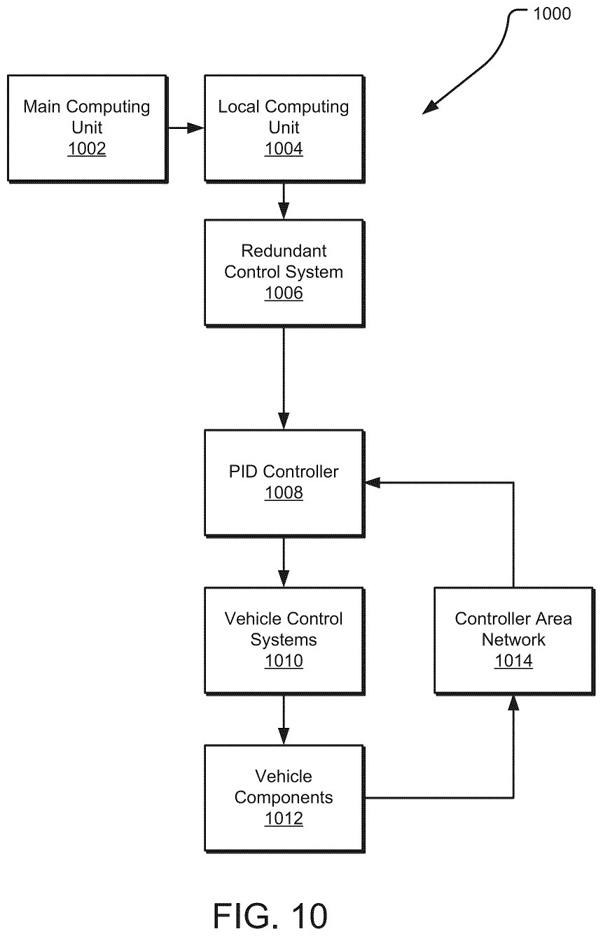

FIG. 10 illustrates an example system 1000 in which a redundant control system 1006 may utilize existing automated controls of a vehicle by providing data communications to a control system of the vehicle. For example, many modern vehicles include software and/or firmware control of various control systems. For instance, autonomous or semiautonomous systems may be provided that allow for control over vehicle systems. One such example of this is a driver assist or lane keeping feature in which actuators are provided to control steering, braking, and/or acceleration may be controlled via software and/or firmware interventions. In such vehicles, the redundant control system 1006 may provide such instructions to the vehicle systems to control the vehicle.

For instance, in FIG. 10, a local computing unit 1004 may interact with a main computing unit 1002 in a manner described above to monitor for a network failure. Upon detection of a network failure, the local computing unit 1004 may alert the redundant control system 1006, which may determine appropriate control commands based on sync data to safely operate the vehicle.

In the system 1000, the redundant control system 1006 may utilize a control feedback controller such as a proportional-integral-derivative (PID) controller 1008. The controller 1008 may provide commands to vehicle control systems 1010. For instance, the controller 1008 may translate or otherwise format the control commands to comply with vehicle standards to allow for the controller 1008 to directly interface with the software/firmware control architecture of the vehicle. In turn, the vehicle control systems 1010 may control vehicle components 1012/such as a braking system or steering system. In turn, a control area network 1014 may monitor vehicle operation such as position of various vehicle controls, forces acting on the vehicle, or other data. Such data may be provided from the control area network 1014 to the controller 1008 to allow for modulation of the control commands for smooth operation of the vehicle as the redundant controls are provided to bring the vehicle into a safe condition.

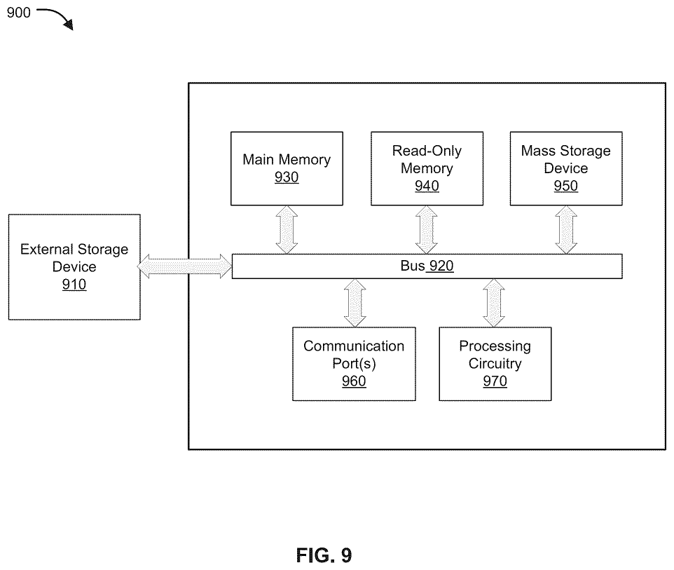

FIG. 9 illustrates an exemplary computer unit in which or with which examples of the present invention may be utilized. Depending upon the particular implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction. As shown in FIG. 9, the computer system may include an external storage device 910, bus 920, main memory 930, read-only memory 940, mass storage device 950, communication port 960, and processor 970.

Those skilled in the art will appreciate that computer system 900 may include more than one processing circuitry 970 and communication ports 960. Processing circuitry 970 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, Hexa-core, or any suitable number of cores) or supercomputer. In some embodiments, processing circuitry 970 is distributed across multiple separate processors or processing units, for example, multiple of the same type of processing units (e.g., two Intel Core i7 processors) or multiple different processors (e.g., an Intel Core i5 processor and an Intel Core i7 processor). Examples of processing circuitry 970 include, but are not limited to, an Intel® Itanium® or Itanium 2 processor(s), or AMD® Opteron® or Athlon MP® processor(s), Motorola® lines of processors, System on Chip (SoC) processors or other future processors. Processing circuitry 970 may include various modules associated with embodiments of the present invention.

Communication port 960 may include a cable modem, integrated services digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. Communication port 960 can be any RS-232 port for use with a modem-based dialup connection, a 10/100 Ethernet port, a Gigabit, or a 10 Gigabit port using copper or fiber, a serial port, a parallel port, or other existing or future ports. Communication port 960 may be chosen depending on a network, such as a Local Area Network (LAN), Wide Area Network (WAN), or any network to which the computer system connects.

Memory 930 may include Random Access Memory (RAM) or any other dynamic storage device commonly known in the art. Read-only memory 940 can be any static storage device(s), e.g., but not limited to, a Programmable Read-Only Memory (PROM) chips for storing static information, e.g., start-up or BIOS instructions for processing circuitry 970.

Mass storage 950 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) 10 recorders, BLU-RAY 3D disc recorders, digital video recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement storage memory 930. Memory 950 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

Bus 920 communicatively couples processor(s) 970 with the other memory, storage, and communication blocks. Bus 920 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 970 to the software system.

Optionally, operator and administrative interfaces, e.g., a display, keyboard, and a cursor control device, may also be coupled to bus 920 to support direct operator interaction with the computer system. Other operator and administrative interfaces can be provided through network connections connected through communication port 960. External storage device 910 can be any kind of external hard drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

Computer system 900 may be accessed through a user interface. The user interface application may be implemented using any suitable architecture. For example, it may be a stand-alone application wholly implemented on computer system 900. The user interfaces application and/or any instructions for performing any of the embodiments discussed herein may be encoded on computer-readable media. Computer-readable media includes any media capable of storing data. In some examples, the user interface application is a client-server based application. Data for use by a thick or thin client implemented on electronic device computer system 900 is retrieved on-demand by issuing requests to a server remote to the computer system 900. For example, computing device 900 may receive inputs from the user via an input interface and transmit those inputs to the remote server for processing and generating the corresponding outputs. The generated output is then transmitted to computer device 900 for presentation to the user.

In some aspects, the techniques described herein relate to a redundant braking system for a remotely piloted vehicle, the system including: a local computing unit configured, at a vehicle, to receive sync data regularly from a main computing unit; receive a heartbeat signal through a communication network from a remote pilot control unit; determine network failure if the heartbeat signal is not received for more than a threshold period of time; and issue a braking command; and an arrangement configured to control the vehicle based on the braking command received from the local computing unit.

In some aspects, the techniques described herein relate to a redundant braking system for a remotely piloted vehicle, the system including: a local computing unit configured, at a vehicle, to receive sync data regularly from a main computing unit; receive a heartbeat signal through a communication network from a remote pilot control unit; determine network failure if the heartbeat signal is not received for more than a threshold period of time; and issue a braking command; and an electromechanical arrangement configured to actuate a brake pedal of the vehicle based on the braking command received from the local computing unit.

In some aspects, the techniques described herein relate to a redundant braking system, wherein the braking command includes any combination of brake time indicator, brake power indicator, or a safety decision matrix.

In some aspects, the techniques described herein relate to a redundant braking system, wherein the braking command is issued based on analysis of the sync data received immediately prior to the network failure.

In some aspects, the techniques described herein relate to a redundant braking system, wherein the sync data includes any or combination of environmental data collected from onboard sensors of the vehicle and instructions received from the remote pilot control unit.

In some aspects, the techniques described herein relate to a system, wherein the local computing unit is configured to generate a steering command to steer the vehicle for safe maneuvering.

In some aspects, the techniques described herein relate to a redundant braking system, wherein the steering command is sent to an onboard vehicle control unit that controls and steers the vehicle for safe maneuvering.

In some aspects, the techniques described herein relate to a redundant braking system, wherein the steering command is generated based on analysis of the sync data received immediately prior to the network failure.

In some aspects, the techniques described herein relate to a redundant braking system, wherein the electromechanical arrangement includes a smart solenoid, an air compressor, a pressure tank, a pneumatic cylinder, and a link rod attached with the brake pedal, wherein the smart solenoid activates the pneumatic cylinder based on the braking command received from the first computer to causes the link rod to actuate the brake pedal.

In some aspects, the techniques described herein relate to a redundant braking system, wherein the electromechanical arrangement includes an electric actuator configured to receive the braking command and actuate the brake pedal based on the braking command.

In some aspects, the techniques described herein relate to a redundant braking system, wherein the electromechanical arrangement includes a pressure supply unit configured to control a hydraulic cylinder to actuate the brake pedal based on the braking command received from the local computing unit.

In some aspects, the techniques described herein relate to a redundant braking method for a remotely piloted vehicle, the method including: receiving, at a local computing unit configured at a vehicle, sync data regularly from a main computing unit; receiving, at the local computing unit, a heartbeat signal through a communication network from a remote pilot control unit; determining, at the local computing unit, network failure if the heartbeat signal is not received for more than a threshold period of time; generating, by the local computing unit, a braking command; and actuating, through an electromechanical arrangement, a brake pedal of the vehicle based on the braking command received from the local computing unit.

In some aspects, the techniques described herein relate to a method, wherein the braking command includes any combination of brake time indicator, brake power indicator, or a safety decision matrix.

In some aspects, the techniques described herein relate to a redundant braking method, wherein the braking command is generated based on analysis of the sync data received immediately prior to the network failure.

In some aspects, the techniques described herein relate to a method, wherein the sync data includes any or combination of environmental data collected from onboard sensors of the vehicle and instructions received from the remote pilot control unit.

In some aspects, the techniques described herein relate to a method, further includes steps of generating, at the local computing unit, a steering command to steer the vehicle for safe parking.

In some aspects, the techniques described herein relate to a method, wherein the steering command is sent to an onboard vehicle control unit that controls and steers the vehicle for safe parking.

In some aspects, the techniques described herein relate to a method, wherein the steering command is generated based on analysis of the sync data received immediately prior to the network failure

In some aspects, the techniques described herein relate to a method, wherein the electromechanical arrangement includes a smart solenoid, an air compressor, a pressure tank, a pneumatic cylinder, and a link rod attached with the brake pedal, wherein the smart solenoid activates the pneumatic cylinder based on the braking command received from the first computer to causes the link to actuate the brake pedal.

In some aspects, the techniques described herein relate to a method, wherein the electromechanical arrangement includes an electric actuator configured to receive the braking command and actuate the brake pedal based on the braking command.

In some aspects, the techniques described herein relate to a method, wherein the electromechanical arrangement includes a pressure supply unit configured to control a hydraulic cylinder to actuate the brake pedal based on the braking command received from the local computing unit.

In some aspects, the techniques described herein relate to a redundant braking system for a remotely piloted vehicle, the system including: a local computing unit configured, at a vehicle, to receive sync data regularly from a main computing unit; receive a heartbeat signal through a communication network from a remote pilot control unit; determine network failure if the heartbeat signal is not received for more than a threshold period of time; and issue a braking command; and an electromechanical arrangement to apply hydraulic force directly on each of a plurality of hydraulic lines of a braking system of the vehicle based on the braking command received from the local computing unit.

In some aspects, the techniques described herein relate to a redundant braking system, wherein the braking command includes any combination of brake time indicator, brake power indicator, or a safety decision matrix.

In some aspects, the techniques described herein relate to a redundant braking system, wherein the braking command is issued based on analysis of the sync data received immediately prior to the network failure.

In some aspects, the techniques described herein relate to a redundant braking system, wherein the sync data includes any or combination of environmental data collected from onboard sensors of the vehicle and instructions received from the remote pilot control unit.

In some aspects, the techniques described herein relate to a system, wherein the local computing unit is configured to generate a steering command to steer the vehicle for safe maneuvering.

In some aspects, the techniques described herein relate to a redundant braking system, wherein the steering command is sent to an onboard vehicle control unit that controls and steers the vehicle for safe maneuvering.

In some aspects, the techniques described herein relate to a redundant braking system, wherein the steering command is generated based on analysis of the sync data received immediately prior to the network failure.

In some aspects, the techniques described herein relate to a redundant braking system, wherein the electromechanical arrangement includes a smart solenoid, an air compressor, a pressure tank, a pneumatic cylinder, and a brake booster that converts mechanical force generated by pneumatic cylinder into hydraulic force that is applied directly on each of the plurality of hydraulic lines of the braking system of the vehicle, wherein the smart solenoid activates the pneumatic cylinder based on the braking command received from the first computer.

In some aspects, the techniques described herein relate to a redundant braking system, wherein the electromechanical arrangement includes an electric actuator configured to receive the braking command and apply hydraulic pressure directly on each of the plurality of hydraulic lines of the braking system of the vehicle based on the braking command.

In some aspects, the techniques described herein relate to a redundant braking system, wherein the electromechanical arrangement includes a pressure supply unit configured to control a hydraulic cylinder to apply hydraulic pressure directly on each of the plurality of hydraulic lines of the braking system of the vehicle based on the braking command received from the local computing unit.

In some aspects, the techniques described herein relate to a redundant braking method for a remotely piloted vehicle, the method including: receiving, at a local computing unit configured at a vehicle, sync data regularly from a main computing unit; receiving, at the local computing unit, a heartbeat signal through a communication network from a remote pilot control unit; determining, at the local computing unit, network failure if the heartbeat signal is not received for more than a threshold period of time; generating, by the local computing unit, a braking command; and applying hydraulic force through electromechanical arrangement directly on each of a plurality of hydraulic lines of a braking system of the vehicle based on the braking command received from the local computing unit.

In some aspects, the techniques described herein relate to a method, wherein the braking command includes any combination of brake time indicator, brake power indicator, or a safety decision matrix.

In some aspects, the techniques described herein relate to a method, wherein the braking command is generated based on analysis of the sync data received immediately prior to the network failure.

In some aspects, the techniques described herein relate to a method, wherein the sync data includes any or combination of environmental data collected from onboard sensors of the vehicle and instructions received from the remote pilot control unit.

In some aspects, the techniques described herein relate to a method, further includes steps of generating, at the local computing unit, a steering command to steer the vehicle for safe parking.

In some aspects, the techniques described herein relate to a method, wherein the steering command is sent to an onboard vehicle control unit that controls and steers the vehicle for safe parking.

In some aspects, the techniques described herein relate to a method, wherein the steering command is generated based on analysis of the sync data received immediately prior to the network failure

In some aspects, the techniques described herein relate to a method, wherein the electromechanical arrangement includes a smart solenoid, an air compressor, a pressure tank, a pneumatic cylinder, and a brake booster that converts mechanical force generated by pneumatic cylinder into hydraulic force that is applied directly on each of the plurality of hydraulic lines of the braking system of the vehicle, wherein the smart solenoid activates the pneumatic cylinder based on the braking command received from the first computer.

In some aspects, the techniques described herein relate to a method, wherein the electromechanical arrangement includes an electric actuator configured to receive the braking command and apply hydraulic pressure directly on each of the plurality of hydraulic lines of the braking system of the vehicle based on the braking command.

In some aspects, the techniques described herein relate to a method, wherein the electromechanical arrangement includes a pressure supply unit configured to control a hydraulic cylinder to apply hydraulic pressure directly on each of the plurality of hydraulic lines of the braking system of the vehicle based on the braking command received from the local computing unit.

While examples of the present invention have been illustrated and described, it will be clear that the present disclosure is not limited to these examples only. Numerous modifications, changes, variations, substitutions, and equivalents, will be apparent to those skilled in the art without departing from the spirit and scope of the disclosure, as described in the claims.

Thus, it will be appreciated by those of ordinary skill in the art that the diagrams, schematics, illustrations, and the like represent conceptual views or processes illustrating examples of the presently disclosed subject matter. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the concepts herein. The subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various examples of the invention, other and further examples of the invention may be devised without departing from the basic scope thereof. The scope of the invention is determined by the claims that follow. The subject matter is not limited to the described examples, which are included to enable a person having ordinary skill in the art to make and use the subject matter herein when combined with information and knowledge available to the person having ordinary skill in the art.

The foregoing description is provided to enable any person skilled in the art to make and use the subject matter. Various modifications to these embodiments will be readily apparent to those skilled in the art, and the novel principles and subject matter disclosed herein may be applied to other examples without the use of the innovative faculty. The claimed subject matter set forth in the claims is not intended to be limited to the examples shown herein but is to be accorded to the widest scope consistent with the principles and novel features disclosed herein. It is contemplated that additional examples are within the spirit and true scope of the disclosed subject matter.

1. A redundant braking system for a remotely piloted vehicle, the system comprising:
a local computing unit configured, at a vehicle, to:
receive sync data regularly from a main computing unit;
receive a heartbeat signal through a communication network from a remote pilot control unit;
determine network failure if the heartbeat signal is not received for more than a threshold period of time; and
issue a braking command; and
an arrangement configured to control the vehicle based on the braking command received from the local computing unit.

2. A redundant braking system for a remotely piloted vehicle, the system comprising:
a local computing unit configured, at a vehicle, to:
receive sync data regularly from a main computing unit;
receive a heartbeat signal through a communication network from a remote pilot control unit;
determine network failure if the heartbeat signal is not received for more than a threshold period of time; and
issue a braking command; and
an electromechanical arrangement configured to actuate a brake pedal of the vehicle based on the braking command received from the local computing unit.

3. The redundant braking system of claim 2, wherein the braking command comprises any combination of brake time indicator, brake power indicator, or a safety decision matrix.

4. The redundant braking system of claim 2, wherein the braking command is issued based on analysis of the sync data received immediately prior to the network failure.

5. The redundant braking system of claim 2, wherein the sync data comprises any or combination of environmental data collected from onboard sensors of the vehicle and instructions received from the remote pilot control unit.

6. The redundant braking system of claim 2, wherein the local computing unit is configured to generate a steering command to steer the vehicle for safe maneuvering.

7. The redundant braking system of claim 6, wherein the steering command is sent to an onboard vehicle control unit that controls and steers the vehicle for safe maneuvering.

8. The redundant braking system of claim 6, wherein the steering command is generated based on analysis of the sync data received immediately prior to the network failure.

9. The redundant braking system of claim 2, wherein the electromechanical arrangement comprises a smart solenoid, an air compressor, a pressure tank, a pneumatic cylinder, and a link rod attached with the brake pedal, wherein the smart solenoid activates the pneumatic cylinder based on the braking command received from the first computer to causes the link rod to actuate the brake pedal.

10. The redundant braking system of claim 2, wherein the electromechanical arrangement comprises an electric actuator configured to receive the braking command and actuate the brake pedal based on the braking command.

11. The redundant braking system of claim 2, wherein the electromechanical arrangement comprises a pressure supply unit configured to control a hydraulic cylinder to actuate the brake pedal based on the braking command received from the local computing unit.

12. A redundant braking method for a remotely piloted vehicle, the method comprising:
receiving, at a local computing unit configured at a vehicle, sync data regularly from a main computing unit;
receiving, at the local computing unit, a heartbeat signal through a communication network from a remote pilot control unit;
determining, at the local computing unit, network failure if the heartbeat signal is not received for more than a threshold period of time;
generating, by the local computing unit, a braking command; and
actuating, through an electromechanical arrangement, a brake pedal of the vehicle based on the braking command received from the local computing unit.

13. The method of claim 12, wherein the braking command comprises any combination of brake time indicator, brake power indicator, or a safety decision matrix.

14. The redundant braking method of claim 12, wherein the braking command is generated based on analysis of the sync data received immediately prior to the network failure.

15. The method of claim 12, wherein the sync data comprises any or combination of environmental data collected from onboard sensors of the vehicle and instructions received from the remote pilot control unit.

16. The method of claim 12, further comprises steps of generating, at the local computing unit, a steering command to steer the vehicle for safe parking.

17. (canceled)

18. The method of claim 16, wherein the steering command is generated based on analysis of the sync data received immediately prior to the network failure.

19. The method of claim 12, wherein the electromechanical arrangement comprises a smart solenoid, an air compressor, a pressure tank, a pneumatic cylinder, and a link rod attached with the brake pedal, wherein the smart solenoid activates the pneumatic cylinder based on the braking command received from the first computer to causes the link rod to actuate the brake pedal.

20. The method of claim 12, wherein the electromechanical arrangement comprises an electric actuator configured to receive the braking command and actuate the brake pedal based on the braking command.

21. The method of claim 12, wherein the electromechanical arrangement comprises a pressure supply unit configured to control a hydraulic cylinder to actuate the brake pedal based on the braking command received from the local computing unit.

22.-41. (canceled)
